(19) United States
(12) Patent Application Publication
(10) Pub. No.: US 2004/0094180 A1
(43) Pub. Date: May 20, 2004

(54) Teeth cleaning brush stick

(75) Inventor: Walter Hsu, Yinlin Hsien (TW)

Correspondence Address: BACON & THOMAS, PLLC, 625 SLATERS LANE, FOURTH FLOOR, ALEXANDRIA, VA, 22314

(73) Assignee: WELTER'S CO., LTD., Yinlin Hsien (TW)

(21) Appl. No.: 10/294,557

(22) Filed: Nov. 15, 2002

(51) Int. Cl. A46B 9/04; A61C 15/02

(52) U.S. Cl. 132/321; 15/167.1; 15/105; 15/184

(57) ABSTRACT

A teeth cleaning brush stick comprises a cleaning rod, a cover, a cleaning brush, and a tool wherein the cleaning rod, integrally molded by plastic, has a holding section disposed at the middle section thereof, and a pointed picking end disposed at one end thereof. The cover is engaged with the other end of the cleaning rod, and the cleaning brush sheltered by the cover thereof is located thereto via the tool thereof. The cleaning brush has flexible brushing wires distributed thereon which can be applied directly onto the crown, the front, or the rear surface of teeth, or extended into the chink of teeth for thorough cleaning thereof. Otherwise, the pointed picking end can also be extended to the chink thereof, easily picking out remains of food or cleaning up the scale or tartar on the teeth, effectively preventing dental diseases like teeth decay. When not in use, said cleaning brush is received at the cover therein for good hygiene and easy carrying thereof. Moreover, the cleaning brush can also be replaced when the brushing wires are worn out of use.

### BACKGROUND OF THE INVENTION

The present invention is related to a teeth cleaning brush stick, comprising a cleaning rod, a cover, a cleaning brush and a tool wherein said cleaning rod, integrally molded by plastic, has a holding section disposed at the middle section thereof, and a pointed picking end disposed at one end thereof. Said cover is engaged with the other end of said cleaning rod, and said cleaning brush sheltered by said cover is also located thereon via said tool. Said cleaning brush is equipped with flexible brushing wires which can be applied directly onto the crown, the front, or the rear surfaces of teeth as well as the chink of teeth for thorough cleaning thereof. In other case, said pointed picking end can also be extended to the chink thereof, easily picking out remains of food or cleaning up tartar on the teeth, effectively preventing diseases like periodontal disease or teeth decay.

Conventional devices for cleaning up teeth include a toothbrush, dental floss, or a toothpick. Said toothbrush is mainly used at home and characterized by brushing wires verified in different arrangement, length, or materials with benefits of either good to use or the effect of massaging teeth gums. Sometime a pointed cleaning means is disposed at one end of said conventional toothbrush for cleaning up teeth at the inner side of oral cavity. And said dental floss is needed for further cleaning of chink between teeth. When one goes outside, said toothpick and dental floss are usually applied, which can only roughly touch the surface, or the chink of teeth without cleaning the tartar on teeth. It is, therefore, quite inconvenient to use said conventional teeth cleaning devices. First, neither one nor all of them can meet the need of thorough cleaning of teeth. Second, it's not easy to carry them all together outside.

### SUMMARY OF THE PRESENT INVENTION

It is, therefore, the primary purpose of the present invention to provide a teeth cleaning brush stick, comprising a cleaning rod having a holding section disposed at the middle section thereof and a pointed picking end disposed at one end thereof, and a cleaning brush sheltered by a cover and located at the other end of said cleaning rod via a tool; whereby, either used at home or carried outside, said teeth cleaning brush stick can easily and effectively clean up the surfaces as well as the chink of teeth.

It is, therefore, the second purpose of the present invention to provide a teeth cleaning brush stick wherein said cleaning brush is provided with flexible brushing wires which can be applied directly onto the crown, the front, or the rear surface of teeth as well the chink of teeth, effectively cleaning up the remains of food or tartar on teeth so as to prevent dental diseases such as periodontal disease.

It is, therefore, the third purpose of the present invention to provide a teeth cleaning brush stick wherein said pointed picking having a triangular cross section is equipped with a flat facet disposed at the top thereof, an arc facet disposed at the bottom thereof, and a plurality of raised parallel lines arranged at both lateral surfaces thereof. With said flat facet thereof abutting against teeth gum for massage thereof, said arc facet thereof can be extended into the chink of teeth for easily picking out remains of food, and by moving back and forth, said raised parallel lines can clean up the scale or tartar attached to teeth, facilitating the health of teeth thereof.

It is, therefore, the fourth purpose of the present invention to provide a teeth cleaning brush stick wherein said cover engaged with slide grooves of said cleaning rod is pushed to the closed end of said slide grooves for said cleaning brush to pass through radially extended slots of said cover and shelter therein for good hygiene or easy carrying when said teeth cleaning brush stick is not in use, or is carried outside.

It is, therefore, the fifth purpose of the present invention to provide a teeth cleaning brush stick wherein said cleaning brush can be replaced when said flexible brushing wires are worn out of use. Said cover is removed first for the worn-out cleaning brush to be detached from said cleaning rod via said tool before a new cleaning brush is applied and reassembled thereto.

### BRIEF DESCRIPTION OF THE DRAWINGS

FIG. 1 is a perspective exploded view of the present invention.

FIG. 1-A is a flat view showing the closed end of the cover of the present invention.

FIG. 2 is top view showing the pointed picking end of the present invention.

FIG. 3 is a sectional view of the present invention in assembly.

FIG. 4 is a diagram showing the present invention in operation.

FIG. 5 is another sectional view showing the withdrawal of said cover thereof.

FIG. 6 is a diagram showing the cleaning up of teeth via the cleaning brush of the present invention.

FIG. 7 is another diagram showing the operation of said cleaning brush thereof.

FIG. 8 is a diagram showing the pointed picking end of the present invention in operation.

FIG. 9 is another diagram showing said pointed picking end in operation.

FIG. 10 is another embodiment of the cover of the present invention.

### DETAILED DESCRIPTION OF THE PREFERRED EMBODIMENTS

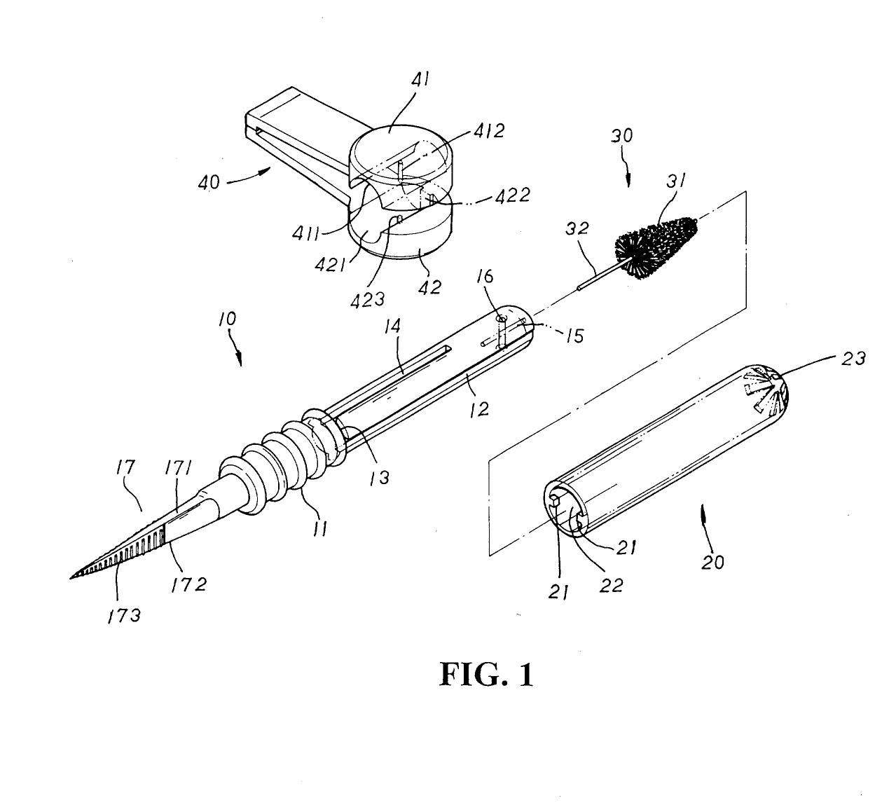

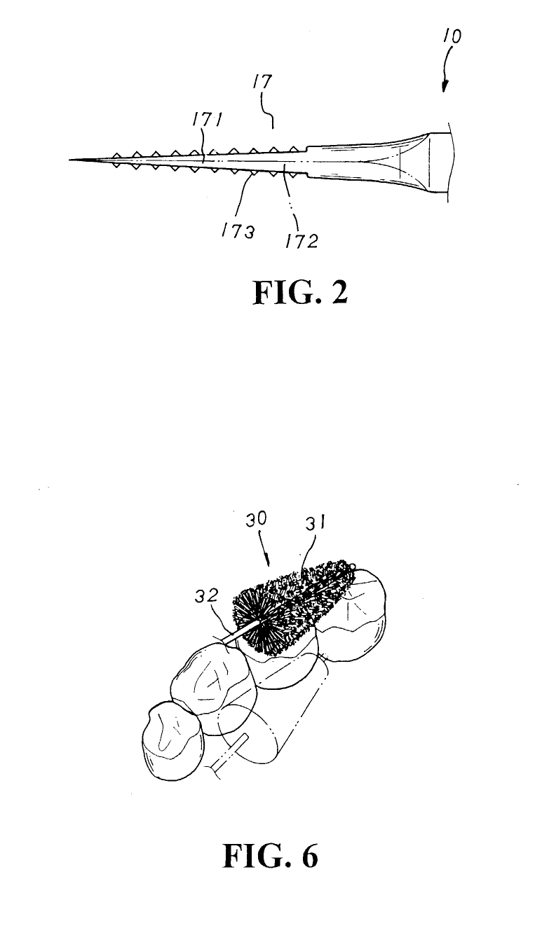

Please refer to FIGS. 1, 2. The present invention is related to a teeth cleaning brush stick, comprising a cleaning rod 10, a cover 20, a cleaning brush 30, and a tool 40. Said cleaning rod 10 is integrally molded by plastic of edible standard, having a holding section 11 with a multiple of ring flanges arranged thereon disposed at the middle section thereof, and a pair of opposite through grooves 12 extending transversely at one side thereof adjacent to said holding section 11 thereof. Each of said opposite through grooves 12 is communicated with a slide groove 14 having a closed end disposed thereon via a connection groove 13 extending longitudinally thereof. An axle hole 15 of proper depth is transversely disposed at one end of said cleaning rod 10 in crisscross with a longitudinal through hole 16 disposed vertically thereon. Said cleaning rod 10 also includes a pointed picking end 17 extending at the other end of said holding section 11 thereof. Said pointed picking end 17, having a triangular cross section, is equipped with a flat facet 171 disposed at the top thereof, an arc facet 172 disposed at the bottom thereof, and a plurality of raised parallel lines 173 arranged at both lateral surfaces thereof.

Said cover 20 is provided with a pair of opposite retaining blocks 21 disposed at the inner edge of one opening end thereof, a housing chamber 22 defined at the interior therein, and radially extended through slots 23 disposed at the other closed end thereof as shown in FIG. 1-A. Said cleaning brush 30 is made up of a flexible axle 32 with flexible brushing wires 31 distributed at one end thereof. Said tool 40 is transversely V-shaped with an upper and a lower clamping lids 41, 42 defining a clamping opening there-between. Said upper clamping lid 41 has an arc groove 411 disposed at the inner side thereof and a long pressing rod 412 with an arc bottom disposed at the middle of said arch groove 411 thereof, while said lower clamping lid 42 has an arc indent 421 with a closed end disposed at the inner side thereof, a pressing block 422 disposed at the closed end of said arc indent 421 thereof, and a short locking rod 423 corresponding to said long pressing rod 412 thereof.

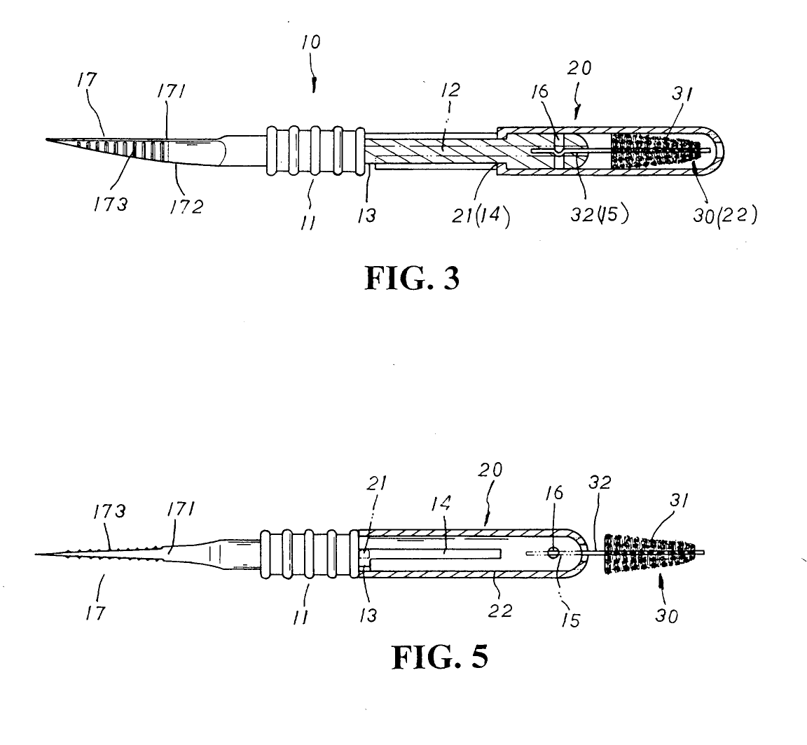

Please refer to FIGS. 3, 4. In assembly, said cleaning brush 30 is adapted to said cleaning rod 10 via said flexible axle 32 thereof led through said axle hole 15 thereof. Said cleaning rod 10 is then located onto the arc indent 421 of said lower clamping lid 42 with one end of said cleaning rod 10 abutted against the pressing block 422 thereof, and the short locking rod 423 thereof inserted to the lower section of the longitudinal through hole 16 thereof. Said upper clamping lid 422 thereof is pushed downwards to said cleaning rod 10 till said long pressing rod 412 thereof is inserted to the upper section of said through hole 16 thereof, abutting and bending said flexible axle 32 for secure location thereof as shown in FIG. 4. The opposite retaining blocks 21 of said cover 20 thereof are led to the opening end of the opposite through grooves 12 of said cleaning rod 10 and pushed to the other end thereof so as to sleeve join said cover 20 with said cleaning rod 10 thereof. The brushing wires 31 of said cleaning brush 30 located at one end of said cleaning rod 10 are led through said radially extended through slots 23 thereof and displayed at the outside thereof. Said cover 20 sleeve joined to said cleaning rod 10 is then rotated, removing said opposite retaining blocks 21 from said through grooves 12 via said connection grooves 13 thereof to relocate at said slide grooves 14 thereof. Said opposite retaining blocks 21 are pushed to the closed end of said slide grooves 14 with said brushing wires 31 re-passing said radially extended through slots 23 and received at the housing chamber 22 of said cover 20 therein.

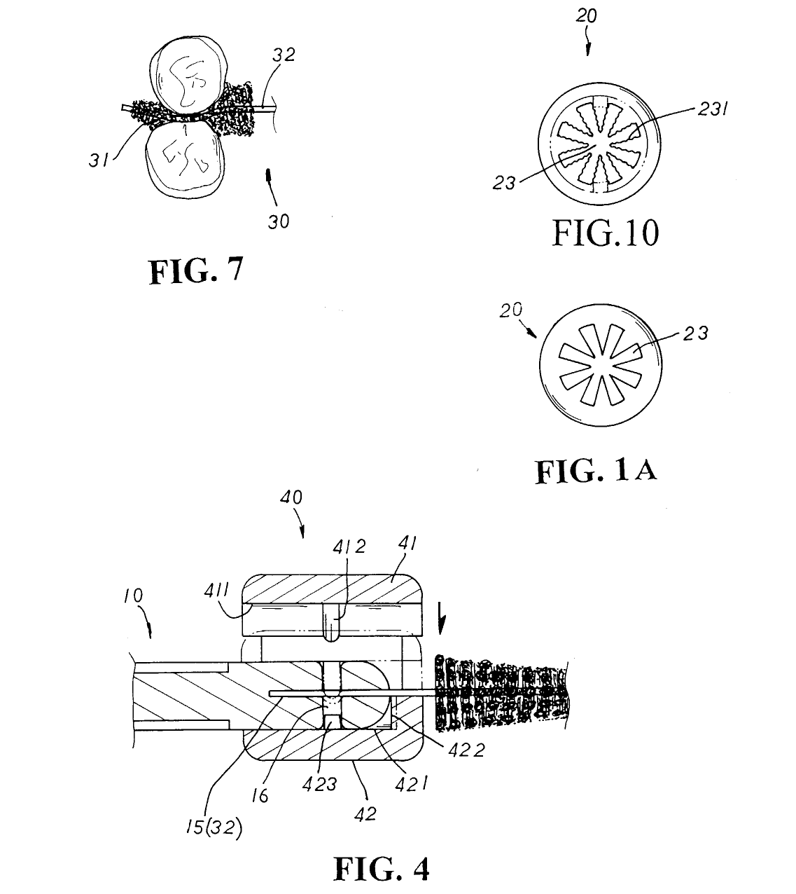

Please refer to FIG. 5. To display said cleaning brush 30 for use, said cover 20 is pushed towards the middle section of said cleaning rod 10, activating said opposite retaining blocks 21 to move on said slide grooves 14 therewith. Said brushing wires 31 thereof will pass through said radially extended through slots 23 and display outside said cover 20 thereof for use. By holding onto said holding section 11, a user can easily clean teeth at the inner side of the oral cavity via said cleaning brush 30, effectively preventing dental diseases such as periodontal disease or tartar on the teeth. The brushing wires 31 of said cleaning brush 30 can be applied directly onto the crown as well as the front and rear surfaces of molar teeth for cleaning-up thereof as shown in FIG. 6. Besides, said brushing wires 31 thereof can also be extended into the adjacent surfaces of teeth thereof for thorough cleaning thereof as shown in FIG. 7.

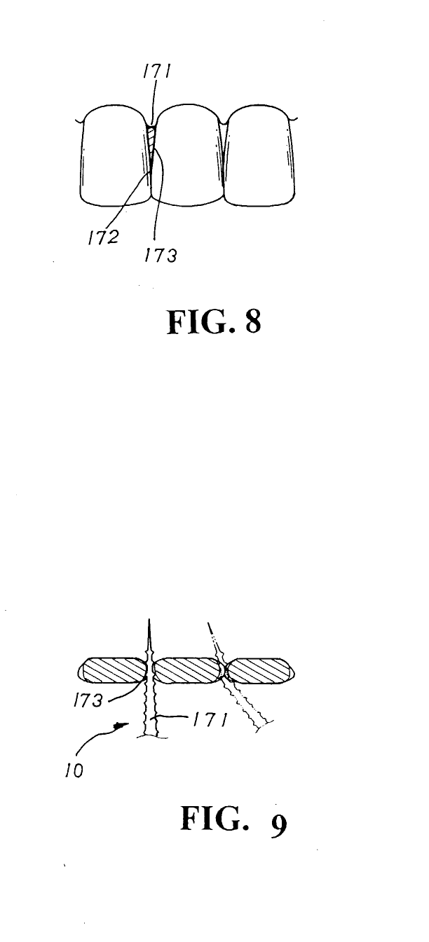

Please refer to FIGS. 8, 9. Holding onto said holding section 11, a user can also clean up the chink between teeth via said pointed picking end 17 thereof. With said flat facet 171 thereof abutting against teeth gum, said arc facet 172 thereof can be extended into the chink thereof or bending in an angle for cleaning up the remains of food. By moving back and forth, the raised parallel lines 173 of said pointed picking end 17 thereof can easily pick out remains of food or clean up the scale or tartar attached to teeth thereof as shown in FIG. 9. Meanwhile, said flat facet 171 thereof can also massage the teeth gum, facilitating the health of teeth as well as cleaning up teeth for preventing diseases like teeth decay.

When not in use or carried outside, said teeth cleaning brush 10 thereof is sheltered by said cover 20 for good hygiene and easy carrying thereof. Said opposite retaining blocks 21 thereof are pushed to the closed end of said slide grooves 14 to store said brushing wires 31 thereof at the housing chamber 22 therein. Moreover, said cleaning brush 30 is also disposable when said brushing wires 31 thereof are worn out of use. Said cover 20 is removed from said cleaning rod 10 first for the worn-out cleaning brush 30 to be detached from said cleaning rod 10 via said tool 40. Said tool 40 is abutted against said cleaning rod 10 with said short locking rod 423 thereof inserted to the upper section of said longitudinal through hole 16 thereof, and the long pressing rod 412 inserted to the lower section of said longitudinal through hole 16 thereof so as to recover the bent flexible axle 32 back to the original state. Thus, said worn-out cleaning brush 30 can be easily detached from said cleaning rod 10 for the replacement of a new one thereof.

Please refer to FIG. 10. The radially extended slots 23 of said cover 20 thereof can also include a multiple of serrated teeth 231 defining the inner edges thereof by which said brushing wires 31 can be cleaned when passing through said radially extended slots 23 to shelter at said housing chamber 22 therein.

What is claimed is:

1. A teeth cleaning brush stick, comprising a cleaning rod, a cover, a cleaning brush, and a tool wherein said cleaning rod, integrally molded by plastic, has a holding section disposed at the middle section thereof, and a pointed picking end disposed at one end thereof; said cleaning brush thereof sheltered by said cover is located at the other end of said cleaning rod thereof via said tool thereof; said teeth cleaning brush stick being characterized by that,
said cleaning brush also including a pair of opposite through grooves extending transversely at one end thereof adjacent to said holding section thereof, each communicating with a slide groove having a closed end disposed thereon via a longitudinal connection groove; an axle hole of proper depth is transversely disposed at one end of said cleaning rod in crisscross with a longitudinal through hole; said pointed picking end thereof, having a triangular cross section, is equipped with a flat facet disposed at the top thereof, an arc facet disposed at the bottom thereof, and a plurality of raised parallel lines arranged at both lateral surfaces thereof;
said cover having a pair of opposite retaining blocks disposed at the inner edge of one opening end thereof, a housing chamber defining the interior therein, and radially extended through slots disposed at the other closed end thereof;
said cleaning brush being made up of a flexible axle with brushing wires distributed at one end thereof;
whereby, to clean up teeth, said brushing wires thereof can be applied directly onto the crown as well as the front and rear surfaces of teeth, or extended into the adjacent surfaces of teeth thereof for thorough cleaning thereof; besides said pointed picking end can also be extended to the chink between teeth, easily picking out remains of food or cleaning up the scale or tartar on the teeth via said raised parallel lines thereof moving back or forth thereon; meanwhile, said flat facet thereof can also massage the teeth gum, facilitating the health of teeth as well as cleaning up teeth for preventing dental diseases like teeth decay.

2. The teeth cleaning brush stick as claimed in claim 1 wherein said tool is transversely V-shaped, having an upper and a lower clamping lids defining a clamping opening there-between; said upper clamping lid having an arc groove disposed at the inner side thereof and a long pressing rod with an arc bottom extending at the middle of said arch groove thereof, while said lower clamping lid having an arc indent with a closed end disposed at the inner side thereof, a pressing block disposed at the closed end of said arc indent thereof, and a short locking rod corresponding to said long pressing rod thereof.

3. The teeth cleaning brush stick as claimed in claim 1 wherein said cleaning rod is made of plastic of edible standards.

4. The teeth cleaning brush stick as claimed in claim 1 wherein the slots disposed at the closed end of said cover are radially extended.

5. The teeth cleaning brush stick as claimed in claim 1 wherein a multiple of serrated teeth can also define the inner edges of said radially extended slots to clean up said brushing wires passing there-through for storage thereof.

6. The teeth cleaning brush stick as claimed in claim 1 wherein said cleaning brush being made up of a flexible axle with flexible brushing wires distributed at one end thereof;

7. The teeth cleaning brush stick as claimed in claim 1 wherein said cleaning brush can also be replaced with a new one when said brushing wires thereof are worn out of use.
